(19) United States
(12) Patent Application Publication
(10) Pub. No.: US 2012/0103879 A1
(43) Pub. Date: May 3, 2012

(54) SORTING INSTALLATION AND SORTING METHOD WITH A PLURALITY OF HOLDING APPARATUSES

(75) Inventor: PETER BERDELLE-HILGE, KONSTANZ (DE)

(73) Assignee: SIEMENS AKTIENGESELLSCHAFT, MUENCHEN (DE)

(21) Appl. No.: 13/285,402

(22) Filed: Oct. 31, 2011

(30) Foreign Application Priority Data
Oct. 29, 2010 (DE) 10 2010 043 133.8
Oct. 29, 2010 (DE) 10 2010 043 155.9
Jul. 8, 2011 (DE) 10 2011 078 902.2
Jul. 8, 2011 (DE) 10 2011 078 903.0

(51) Int. Cl. B07C 5/00

(52) U.S. Cl. 209/509

(57) ABSTRACT

A sorting installation and a sorting method sort articles, in particular flat mail items, by use of a plurality of holding apparatuses on a basis of a sorting feature. The sorting installation contains a plurality of sorting outputs, a loading station and a plurality of holding apparatuses. Each holding apparatus contains two side surfaces which are connected to each other by at least two connecting elements. Each connecting element contains two connecting components. The two connecting components are connected to each other in an articulated manner and are connected in an articulated and resilient manner to a side surface. For each article, it is measured what value the sorting feature assumes. An article is put into the space which is located between the side surfaces and the connecting element. The holding apparatuses with the articles are sorted. The article is removed again from the holding apparatus by the grippers.

### CROSS-REFERENCE TO RELATED APPLICATION

This application claims the priority, under 35 U.S.C. §119, of German application Nos. DE 10 2010 043 133.8, filed Oct. 29, 2010, DE 10 2010 043 155.9, filed Oct. 29, 2010, DE 10 2011 078 902.2, filed Jul. 8, 2011 and DE 10 2011 078 903.0, filed Jul. 8, 2011; the prior applications are herewith incorporated by reference in their entirety.

### BACKGROUND OF THE INVENTION

### Field of the Invention

The invention relates to a sorting installation and to a sorting method for sorting articles, in particular flat mail items, by a plurality of holding apparatuses on the basis of a prescribed sorting feature.

Various methods have been proposed for sorting mail items by each mail item being put in a respective holding apparatus, the filled holding apparatuses being sorted and the mail items subsequently being removed again from the holding apparatuses. Sorting installations and sorting methods for rapidly and reliably removing mail items again from the sorted holding apparatuses are desired.

U.S. Pat. No. 7,629,552 B2 describes a sorting installation for flat mail items with a multiplicity of holding apparatuses (“holders”, “escorts”). Each holding apparatus has two side surfaces (“side surfaces 100a, 100b”), an upper connecting surface (“top surface 100c”) and a base (“bottom 110”). The base 110 and the upper connecting surface 110c are connected rotatably to the side surfaces 100a, 100b, specifically by a plurality of hinges (“hinges 102, 104, 106, 108”, see FIG. 2). The hinge 108 between the base 110 and the side surface 100a can be released such that the base 110 can be folded away. The holding apparatus hangs on at least one hook (“hanger 222”). A flat mail item is pushed in a vertical position laterally between the two side surfaces 100a, 100b. The base 110 and the upper connecting surface 100c are situated vertically here on the two side surfaces 100a, 100b. The holding apparatus is subsequently folded together with the mail item, and therefore the two side surfaces 100a, 100b bear against the mail item and the holding apparatus has a cross section in the form of a parallelogram. The mail items are transported and sorted in the holding apparatuses. In order to remove the mail item, the holding apparatus is unfolded again.

U.S. Pat. No. 4,169,529 describes an “item transport apparatus”, for example, for flat mail items. Each article (“item”, “document 14”) is transported in a “carrier 10”. The “carrier 10” hangs on a “transport means belt 26” by a hook-shaped “slotted hanger-like element 24”, see FIG. 1, FIG. 2, FIG. 4 and FIG. 5. The hook-shaped element 24 is connected to a planar “side member 16”. The “side member 16”, a further planar “side member 18”, an “upper support section 20” and a “lower support section 22” enclose a space from four sides, the space being open to the remaining two sides. The enclosed space is capable of receiving a “document 14”, see FIG. 1. Two openings 34, 34′ are let into the side surfaces 16, 18. The two side surfaces 16, 18 are connected to the base 22 by two “hinged couplings along lines 32, 32′”, see FIG. 2. The two side surfaces 16, 18 are correspondingly connected to the roof 20 by two “hinged couplings along lines 30, 30′”. As a result, the “carrier 10” can be folded up, see FIG. 4, and unfolded again, see FIG. 1 and FIG. 2. A “carrier 10” which is empty and is folded up is transported away via two rising conveyor belts (“drive pulleys 46, 46′”), and thereby raised and unfolded, see FIG. 6. A “document insertion belt 48” pushes an article 14 in the direction of the arrow 15 into the unfolded “carrier 10”. The filled “carrier 10” is transported further and is then no longer supported, as a result of which gravity folds up the filled “carrier 10” again. For unloading, the folded up “carrier 10” is transported away via two “carrier unloading opener belts 54” and thereby unfolded again. A “moving vacuum remover belt 56” grips the article 14 in the unfolded “carrier 10” through the recesses 34, 34′ and pulls the article 14 out of the “carrier 10”.

U.S. Pat. No. 5,125,500 describes a sorting installation for flat articles. A “closed loop conveyor-distributer 9” transports articles (“objects 14”) by a plurality of hanging “object supports 1”. A “closed loop conveyor-elevator 10” with “second object supports 29” in the form of forks is located below the “conveyors 9”, thus producing a sequence of compartments, see FIG. 4. The “object supports 1” also called “object grippers 1”, are activated by a cam (“cam 42”) and a plurality of projections (“retractable abutments 19”). Each “object support 1” has a “base 1a”, which is fastened to a chain, a “front mobile arm 11” and a “rear mobile arm 12”. The two arms 11, 12 are connected to the “base 1a”, see FIG. 1. The “front mobile arm 11” is mounted rotatably about a shaft (“shaft 17”) and is connected via a yoke (“yoke 17a”) to vertical “pins 13”. The two arms 11, 12 are connected resiliently to each other and to the “base plate 1a” by a spiral spring 22. The forks 29 of the lower “conveyor 10” can penetrate the “pins 13” and the arms 11, 12 of an “object support 1”, see FIG. 4.

U.S. patent publication No. 2009/0000996 A1 describes a sorting installation for flat mail items with a multiplicity of holding apparatuses. Each holding apparatus holds a mail item centrally in the manner of a wash peg. The holding apparatuses are suspended on a rod-shaped transporting apparatus and are transported by the transporting apparatus, wherein the mail items hang on the holding apparatuses, see FIG. 7. A holding apparatus with a mail item can rotate about an axis which runs perpendicularly to the article plane of the mail item and parallel to the transporting direction, see FIG. 8.

International patent disclosure WO 2009/035694 A1, corresponding to U.S. patent publication No. 2011/0046775, describes a sorting installation for flat mail items. Each mail item is transported in a dedicated holding apparatus (“frame”). Various refinements for extracting a mail item again from a holding apparatus of this type (“frame F”) are described.

In one refinement of international disclosure WO 2009/035694 A1, a holding apparatus has a “movable sliding component 11045” and a “static component 11046”, see FIG. 11Ea to FIG. 11Ec and paragraph [0720]. By use of two connecting elements, the distance between the two side surfaces 11045 and 11046 can be changed, see FIG. 11Ec and paragraph [0723]. In another refinement, a “sub-frame 11066” is mounted movably on a rectangular “frame 11065” by a plurality of “hinged lever-arms 11072”, see FIG. 11Fa to FIG. 11Fd and paragraph [0724] et seq. The “sub-frame 11066” and the “frame 11065” can be folded up and unfolded, see paragraph [0728]. In a further refinement, a “frame 11075”, a “sub-frame 11076” and a “bottom ledge 11081” enclose a space, see FIG. 11Ga to FIG. 11Gc and paragraph [0730] et seq. The “sub-frame 11076” is connected to the “frame 11065” by the base 11081 and two “hinged upper lever-arms 11082”, and therefore the holding apparatus can be folded up and unfolded.

In a further refinement, a “frame 11085” holds a rigid “sub-frame 11086” and a “flexible membrane 11091”, see FIG. 11H and paragraph [0738]. The “sub-frame 11086” is connected to the “frame 11085” at the top via “hinges 11092” and at the bottom via “bottom tabs 11093” and “catches 11094”, see paragraph [0739]. In the refinement of FIG. 11I, a plurality of mail items can be removed simultaneously from the respective holding apparatuses thereof, see paragraph [0744]. A rectangular “frame 11095” is provided with four “tabs 11097” at the four corners, see paragraph [0740]. A V-shaped “folder 11096” is connected to the “frame 11095” by four “elastic bands 11101”, see paragraphs [0742] and [0743].

In the “frame 11095” and the “folder 11096”, “holes 11103”, through which respective “rods 11104” are guided, are let into the base, see paragraph [0743]. The “rods 11104” are raised such that the mail items stand on the “rods 11104”. The “rods 11104” are rotated and thereby push the mail items horizontally out of the holding apparatuses, see FIG. 11I and paragraph [0746]. The mail items can additionally be removed from the holding apparatuses by means of vibration, see paragraph [0747].

In a further refinement of international patent disclosure WO 2009/035694 A1, a “frame 11115” has a “folder 11116” and four hook-shaped “actuation tabs 11118” and “11119” at the corners, see FIG. 11J and paragraph [0749]. The “folder 11116” has two side surfaces (“front membrane 11116a, back membrane 11116b”) which are mechanically connected to each other. In order to open the “folder 11116”, the “actuation tabs 11118, 11119” are rotated from a vertical, closed position into a horizontal, open position and the side surfaces 11116a, 11116b move apart, see paragraph [0752]. A C-shaped recess 11121 is let into the “front membrane 11116a”, see FIG. 11J and paragraph [0752]. A “vacuum pick-head” grips a mail item M in the “folder 11116” through the recess 111121, see paragraph [0752]. In another refinement, a C-shaped recess is also let into the “back membrane 11116”. A plurality of “frames 11115” is transported past a stationary “vacuum pick-head”, and the one “pick-head” grips the mail items M in the holding apparatuses through the C-shaped recesses, see paragraph [0753].

FIG. 32A to FIG. 32E from international patent disclosure WO 2009/035694 A1 show a holding apparatus which clamps a mail item centrally. The holding apparatus hangs in a rail and is moved in the rail.

International patent disclosure WO 2009/126157 A1, corresponding to U.S. patent publication No. 2011/0029127, also describes a sorting installation with a multiplicity of holding apparatuses for one mail item each. In a refinement, each holding apparatus is provided with a machine-readable identification. The holding apparatus hangs on a rail-shaped transporting apparatus by a hook. The holding apparatus has a clamp with two bent claws (“jaws 32a, 32b”). A mail item is gripped by the claws 32a, 32b and holds the mail item which, as a result, hangs on the clamp in a vertical position, see FIG. 3. Guide elements (“taps 34a, 34b”), through which rod-shaped elements (“shafts/rods”) can be guided, are fastened to the clamps 32a, 32b in order to be able to vary the distance between the claws 32a, 32b and to hold the claws.

U.S. Pat. No. 7,527,261 B2 describes a sorting installation for flat mail items of various dimensions (“mixed mail sorter”). Each mail item is transported by an “escort assembly 14” and then deposited into a “containment device 16”, for example into a “mail tray”. The “escort assembly 14” is preferably in the form of a clamp (“clamp”), but may also be configured as a pocket (“movable pocket”) or as a wire cage (“wire form cage”). The clamp 14 has a plurality of claws (“jaws 14a, 14b”) which are held in a closed position by a spring. The clamps 14a, 14b can be opened in order to release a mail item again.

### SUMMARY OF THE INVENTION

It is accordingly an object of the invention to provide a sorting installation and a sorting method with a plurality of holding apparatuses which overcomes the above-mentioned disadvantages of the prior art devices of this general type, by which the same holding apparatus is capable of holding articles of differing thicknesses in succession without an article being able to slip out of the holding apparatus.

The sorting installation according to the solution has at least one loading station, at least one unloading station, a measuring instrument, a sorting and transporting device, and a plurality of holding apparatuses.

Each holding apparatus contains two mutually parallel side surfaces and at least two spaced-apart connecting elements between the two parallel side surfaces.

The two side surfaces and the at least two connecting elements together enclose a space. The holding apparatus is capable of holding an article to be sorted when the article is located in the enclosed space.

Each of the at least two connecting elements is connected in an articulated manner to the two side surfaces.

In the case of at least one holding apparatus of the sorting installation, each connecting element between the side surfaces contains two connecting components in each case. The two connecting components of a connecting element are connected to each other in an articulated manner. One connecting component in each case is connected in an articulated manner to one side surface in each case. Each side surface is connected in an articulated manner to at least one connecting component of the connecting element.

Furthermore, each connecting element is resiliently and mechanically connected to at least one side surface, namely by a spring element. The holding apparatus therefore has at least two spring elements. Each spring element acts on at least one connecting element between two side surfaces in such a manner that the spring force endeavors to reduce the distance between the two side surfaces. If the distance between the side surfaces is increased, a restoring spring force or at least every spring element is brought about, the force acting counter to the increase in distance. In this manner, the holding apparatus is capable of clamping an article between the side surfaces thereof and, by the clamping, of preventing the article from slipping out of the holding apparatus. The article is on the contrary held fixedly in the holding apparatus.

The sorting installation sorts a plurality of articles in accordance with a prescribed sorting feature. The sorting installation is configured in such a manner that the sorting installation carries out the now described steps for each article to be sorted. The measuring instrument measures what value the sorting feature assumes for this article. A loading station puts the article into a holding apparatus. After being put in, the article is located in the space between the two side surfaces and the at least one connecting element. The sorting and transporting device transports the holding apparatus together with the article to an unloading station. The unloading station removes the article from the holding apparatus.

The sorting and transporting device sorts articles when the articles are in the holding apparatuses. For this purpose, the sorting and transporting device sorts the filled holding apparatuses, specifically depending on the measured sorting feature values of the articles in the holding apparatuses.

Each article is held by the holding apparatus throughout the transport from a loading station to an unloading station. This makes it possible to transport the article in a space-saving manner. In particular, it is possible to transport the article in such a manner that an article plane, in which the article extends, is arranged perpendicularly or obliquely to the respective transporting direction. This effect cannot be obtained with conveyor belts as the transporting device and without a holding apparatus.

The side surfaces and the connecting elements of the holding apparatus according to the solution enclose a space into which an article can be put. The article can be brought into the space and can be removed again from the space. A holding apparatus according to the solution can be loaded in movement by an article being pushed into the enclosed space while the holding apparatus is moved. A clamp can be reliably connected to an article only with a complicated synchronization in the movement.

The refinement of the holding apparatus with the resilient connection between a connecting element and a side surface increases the contact pressure of the side surface on the article in the holding apparatus and therefore the friction between the side surface and the article. The two side surfaces press resiliently from two sides against the article in the holding apparatus. This reduces the risk of the article slipping out of the holding apparatus during transport. This refinement also makes it possible for the same holding apparatus to be capable of holding articles of differing thickness in succession and for the sorting installation to contain a plurality of identical holding apparatuses and nevertheless to be capable of transporting articles of differing thickness.

Owing to the spring elements, the side surfaces exert a planar contact pressure against an article in the enclosed space. The planar contact pressure reduces the risk in comparison to a refinement in which part of the holding apparatus exerts a punctiform pressure on an article in order to hold the article. A clamp exerts such a punctiform pressure. The article is better held by the spring elements than if the holding apparatus were folded merely by gravity and thereby holds the article.

The refinement in which the connecting element has two connecting components makes it easier to adapt the holding apparatus successively to articles of differing thickness and to use the same holding apparatus successively for articles which are to be sorted and are of differing thickness. The holding apparatus takes up less space than a holding apparatus with a single-piece connecting element.

In one refinement, the holding apparatus has two side surfaces, and two connecting elements which are divided into two connecting components in each case. Each connecting component is connected to another connecting component of the same connecting element and to a side surface in an articulated manner and by a spring element. The holding apparatus therefore has four connecting components and six spring elements. In another refinement, the holding apparatus has fewer spring elements, for example only two spring elements or four spring elements. Two connecting elements are indeed connected to each other and/or to a side surface in an articulated manner, but without spring elements.

The following refinements reduce the risk even further of an article slipping out of the holding apparatus, even if the holding apparatus is loaded with articles of differing thickness in succession. Two connecting elements each have a spring element or two spring elements, wherein the article is located in the space between the two side surfaces and the two connecting elements.

Two connecting elements each have two connecting components, wherein the article is located in the space between the two side surfaces and the two connecting elements with the two connecting components in each case.

At least one side surface is made of an elastic material, and at least one side surface is arched in such a manner that the connecting element is a concave object—as seen in cross section.

The holding apparatus together with an article preferably hangs on a guiding device of the transporting device during transport in such a manner that the connecting element with the connecting components is located below the two side surfaces. The two connecting components form a V in cross section. The angle between the limbs of the V can be changed owing to the articulated connection. The two connecting components thereby form a channel. An article in the holding apparatus is located in the channel and is held by the channel and by the two side surfaces.

The sorting installation is preferably used in order to sort flat articles of differing thickness. Each flat article to be sorted extends in a respective article plane. If the flat article is placed in a holding apparatus, the two side surfaces and the article plane of the article are parallel to each other.

In one refinement, the sorting installation has a plurality of sorting outputs. For each holding apparatus with an article, a sorting output is selected, specifically depending on the sorting feature value of the article in the holding apparatus. The holding apparatus with the article is transported to the selected sorting output.

In a development of this refinement, a plurality of sorting passes are passed through in succession because there are more possible sorting feature values than sorting outputs of the sorting installation. In this refinement, each article is placed into a respective holding apparatus by the loading station during the first sorting pass and remains in the holding apparatus until the final sorting pass has finished.

In another refinement, an order among the occurring sorting feature values is prescribed. The filled holding apparatuses are placed in a sequence—or a plurality of subsets of filled holding apparatus are placed into a respective sequence. The arrangement for the filled holding apparatuses in the sequence corresponds to the prescribed value order.

The spring element used is, for example, a compression spring or a tension spring or else a gas-filled piston. Any other element which exerts a resilient action is also possible. The spring element may comprise a plurality of individual springs.

In one refinement, a recess is let into each of the two sides of the holding apparatus. The two recesses form a continuous opening. This makes it possible for a gripping apparatus having two grippers to grip an article in the holding apparatus from both sides through the opening and to pull the article out of the holding apparatus. The article is not damaged in the process.

Other features which are considered as characteristic for the invention are set forth in the appended claims.

Although the invention is illustrated and described herein as embodied in a sorting installation and a sorting method with a plurality of holding apparatuses, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a sorting installation with a plurality of holding apparatuses according to the invention;

FIG. 2 is a diagrammatic, perspective view of the holding apparatus with a centrally mounted coupling element and two recesses;

FIG. 3 is an illustration showing the holding apparatus of a centrally mounted coupling element in front view with a thin mail item;

FIG. 4 is an illustration showing the holding apparatus from FIG. 3 with a thick mail item instead of a thin one;

FIG. 5 is an illustration showing the holding apparatus with two concavely bent side surfaces in front view;

FIG. 6 is an illustration showing the holding apparatus with two lateral coupling elements and two recesses in side view; and

FIG. 7 is an illustration showing a continuous opening which is formed by two recesses.

### DETAILED DESCRIPTION OF THE INVENTION

In the exemplary embodiment, the invention is used to transport flat mail items within a sorting installation. Each mail item to be sorted is provided with an identifier of a destination to which the mail item is to be transported. Each flat mail item extends in a respective article plane.

The sorting installation has a feeder for mail items together with a singulator, a reader for destination addresses, at least one loading station, a multiplicity of holding apparatuses, at least one unloading station, and a multiplicity of sorting outputs.

The mail items are fed to the feeder, and the singulator produces a stream of upright mail items which are transported to the loading station.

In the loading station, a respective mail item is automatically pushed into a holding apparatus or put into the holding apparatus in another manner. The holding apparatuses together with the mail items are transported through the sorting installation as far as a respective sorting output.

The reader has a camera and an image evaluation unit. The camera produces a computer-accessible image of the mail item before the mail item is put into the holding apparatus. The image shows the destination identifier on the mail item. The image evaluation unit deciphers the destination identifier while the mail item is transported through the sorting installation.

A selection unit evaluates a prescribed computer-accessible sorting plan and selects a sorting output. The sorting output which the selection unit selects depends on the deciphered destination identifier and on a prescribed computer-accessible sorting plan. The sorting plan allocates a respective sorting output to each possible destination identifier. After the camera has produced the image of the mail item, the mail item reaches the loading station, and the loading station puts the mail item into the holding apparatus. The mail item is transported in the holding apparatus to the selected sorting output and remains in the holding apparatus at least until the holding apparatus with the mail item reaches the selected sorting output.

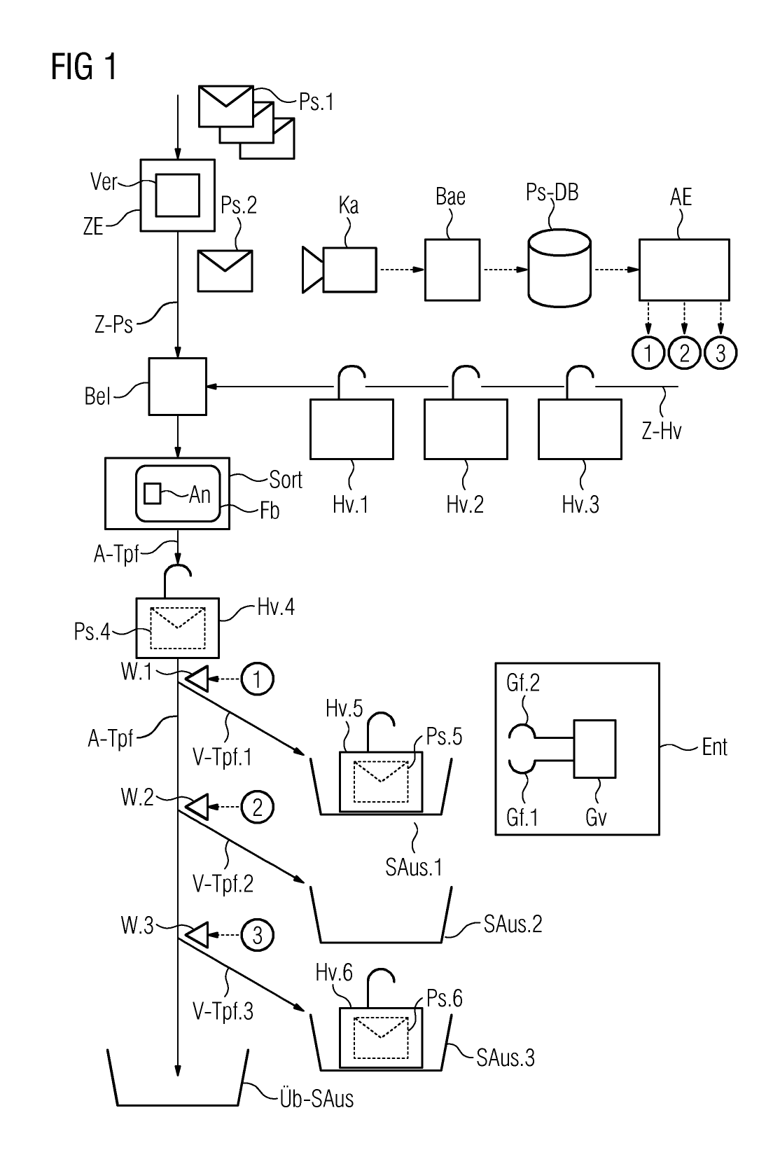

FIG. 1 shows schematically a sorting installation which has the following components:

a feeder ZE with a singulator Ver,
a reader with a camera Ka and an image evaluation unit Bae,
a mail item data store Ps-DB,
a selection unit AE,
a loading station Bel,
a sorting and transporting device Sort with a closed conveyor track Fb and a drive An for holding apparatuses on the conveyor track Fb,
an unloading station Ent with a gripping apparatus Gv,
six holding apparatuses Hv.1, . . . , Hv.6,
three sorting outputs SAus.1, SAus.2, SAus.3,
an overflow sorting output Üb-SAus,
a feed transporting path Z-Ps for singulated mail items,
a feed transporting path Z-Hv for empty holding apparatuses,
an outward transfer transporting path A-Tpf for holding apparatuses which are filled with mail items,
three connecting transporting paths V-Tpf.1, V-Tpf.2, V-Tpf.3 to the three sorting outputs SAus.1, SAus.2, SAus.3 and
three separating filters W.1, W.2, W.3 in the outward transfer transporting path A-Tpf, which are activated by the selection unit AE.

It is also possible for a plurality of loading stations or a plurality of unloading stations to operate in parallel. For example, each sorting output SAus.1, SAus.2, . . . can have a dedicated unloading station.

In FIG. 1, material flows are indicated by solid arrows and data flows by dashed arrows.

In addition, six mail items Ps.1, . . . , Ps.6 are shown. The three mail items Ps.4, Ps.5 and Ps.6 have already been placed into the respective holding apparatuses Hv.4 and Hv.5 and Hv.6. The holding apparatus (Hv.4) with the mail item (Ps.4) is just being transported along the outward transfer transporting path (A-Tpf). The holding apparatuses Hv.5, Hv.6 with the mail items Ps.5, Ps.6 have already been put into the sorting outputs SAus.1 and SAus.3, respectively. The holding apparatuses Hv.1, Hv.2, Hv.3 are still empty, and the mail items PS.1, Ps.2, Ps.3 are not yet located in a holding apparatus. The mail item Ps.1 is part of a stack of mail items which have not yet been singulated. The singulated mail item Ps.2 is located in the feed transporting path Z-Ps and upstream of the camera Ka.

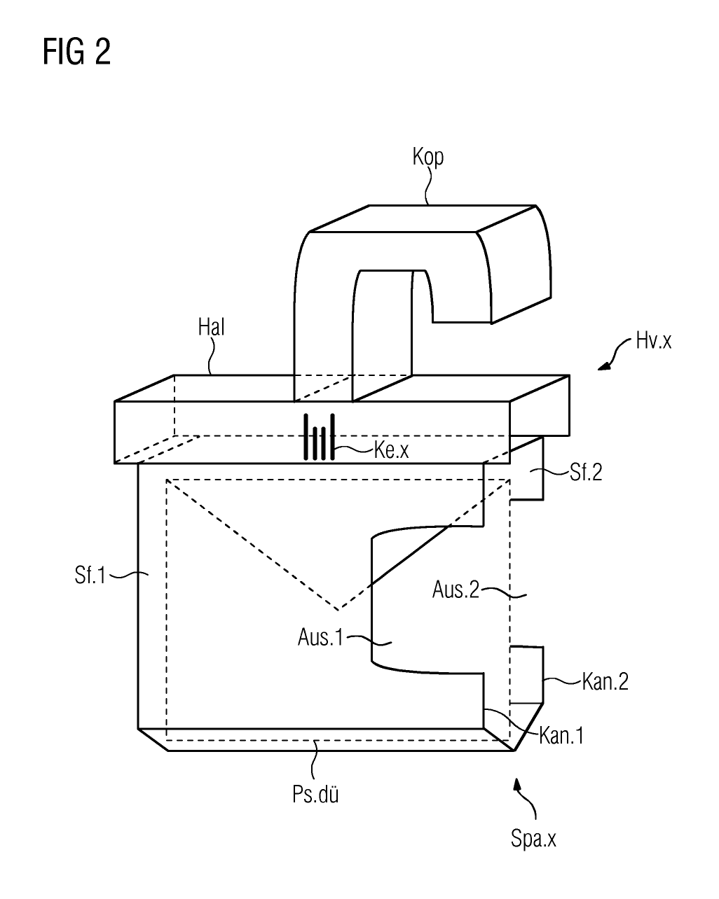

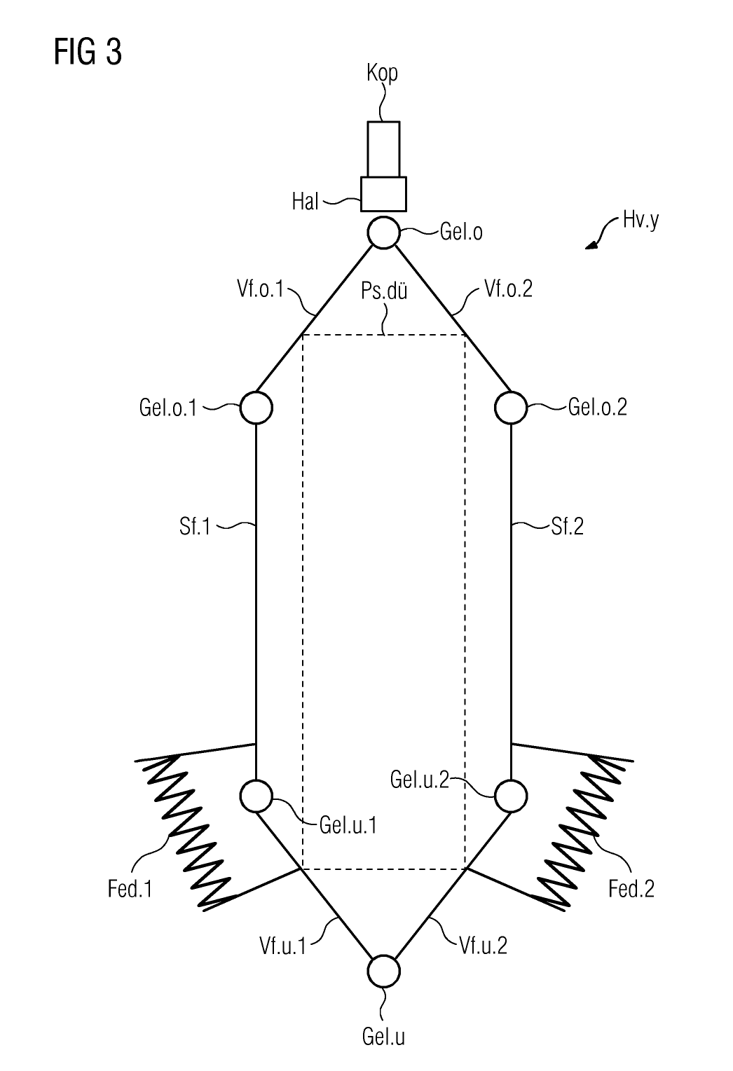

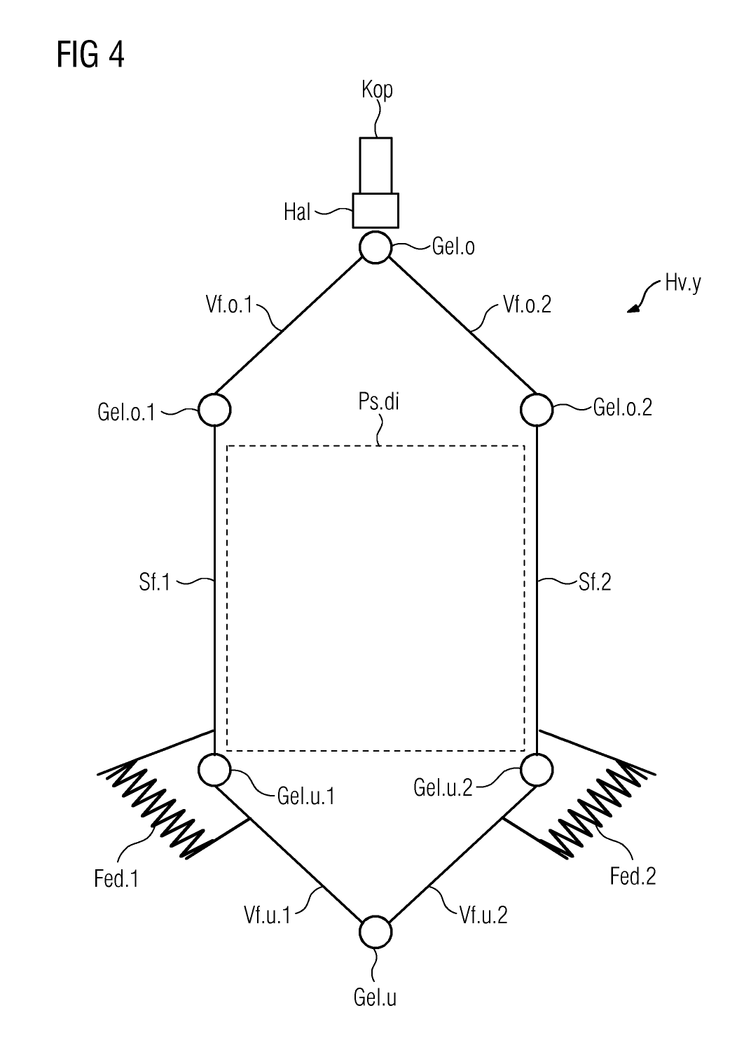

FIG. 2 shows a side view of a holding apparatus Hv.x according to the solution. A cross section through the holding apparatus Hv.y is shown in FIG. 3 and FIG. 4. The side surfaces and the article plane of the mail item Ps.dü and Ps.di lie in the plane of projection of FIG. 2 and are perpendicular to the planes of projection of FIG. 3 and FIG. 4.

The holding apparatuses Hv.x, Hv.y contains:

a centrally mounted coupling element Kop,
a rigid holder Hal,
two side surfaces Sf.1, Sf.2,
an upper connecting element Vf.o with two connecting components Vf.o.1, Vf.o.2,
a lower connecting element Vf.u with two connecting components Vf.u.1, Vf.u.2,
two spring elements Fed.1, Fed.2, and
six articulated connections Gel.o.1, Gel.o.2, Gel.o.3, Gel.u.1, Gel.u.2, Gel.u.3.

A flat mail item can be pushed through the gap Spa.x, Spa.y into the holding apparatus Hv.x, Hv.y and removed again from the holding apparatus Hv.x, Hv.y.

The upper articulated connection Gel.o is fastened to the rigid holder Hal and holds the two connecting components Vf.o.1 and Vf.o.2 of the upper connecting surface Vf.o. The articulated connection Gel.o.1 is located between the side surface Sf.1 and the connecting component Vf.o.1 of the upper connecting element Vf.o. The articulated connection Gel.o.2 is located between the side surface Sf.2 and the connecting component Vf.o.2 of the upper connecting element Vf.o. The articulated connection Gel.u.1 is located between the side surface Sf.1 and the connecting component Vf.u.1 of the lower connecting element Vf.u. The articulated connection Gel.o.2 is located between the side surface Sf.2 and the connecting component Vf.u.2 of the lower connecting surface Vf.u.

In the exemplary embodiment, the two spring elements Fed.1, Fed.2 each have at least one compression spring. In order to compress the compression springs, a force has to be exerted on the spring elements Fed.1, Fed.2. During the expansion, the compression springs endeavor to bring the connecting components Vf.u.1 and Vf.u.2 in line with the side surfaces Sf.1, Sf.2. The distance between the two side surfaces Sf.1, Sf.2 of the holding apparatus Hv.y can be increased counter to the force of the spring elements Fed.1, Fed.2. The spring elements Fed.1, Fed.2 are preferably configured as spiral springs and are let into and integrated in the lower articulated connections Gel.u.1, Gel.u.2. It is also possible likewise to mount a respective spring element on the connecting components Vf.o.1 and Vf.o.2 of the upper connecting component Vf.o, for example, by a compression spring.

FIG. 3 shows the holding apparatus Hv.y in a cross-sectional illustration with a thin mail item Ps.dü. FIG. 4 shows the same holding apparatus Hv.y from the same viewing direction as in FIG. 3 with a thick mail item Ps.di instead of the thin mail item Ps.dü. The thickness of the mail items Ps.dü, Ps.di is illustrated in exaggerated form. The side surfaces Sf.1, Sf.2 are perpendicular to the planes of projection of FIG. 3 and FIG. 4.

In FIG. 4, the spring elements Fed.1, Fed.2 are compressed to a greater extent than in FIG. 3 and exert a greater restoring force on the side surfaces Sf.1, Sf.2. The side surfaces Sf.1, Sf.2 therefore exert a greater force on the thick mail item Ps.di than on the thin mail item Ps.dü. This is expedient because, as a rule, a thick mail item is also heavier than a thin mail item.

As already explained, the loading station Bel puts each mail item Ps.1, Ps.2, . . . into a respective holding apparatus Hv.1, Hv.2, . . . , after the camera Ka has produced an image of that surface of the mail item Ps.1, Ps.2, . . . on which the destination address is placed. The mail item Ps.1, Ps.2, . . . is preferably put into a previously empty holding apparatus Hv.1, Hv.2, . . . , and therefore only one mail item is located in the holding apparatus at each moment, i.e. a holding apparatus does not simultaneously hold two mail items. The mail item is pushed into the space between the two side surfaces Sf.1, Sf.2 and the two connecting elements Vf.o, Vf.u. In the exemplary embodiment, each mail item Ps.1, Ps.2, . . . is pushed from the side into a holding apparatus Hv.x, Hv.y, . . . , specifically either from the side on which the recesses Aus.1, Aus2 are arranged, or from the other side. It is also possible to allow the mail item to slide into a holding apparatus from above.

In one refinement, each holding apparatus is provided with a unique machine-readable identification. This identification is, for example, in the form of a bar pattern (“bar code”) or is stored in a data carrier which can be read contactlessly, the data carrier being connected to the holding apparatus. The unique identification differentiates the holding apparatus from all other holding apparatuses in the sorting installation. The sorting installation has at least one reader for a machine-readable identification of this type on a holding apparatus. The reader is mounted on the outward transfer transporting path and transmits reading results to the selection unit AE.

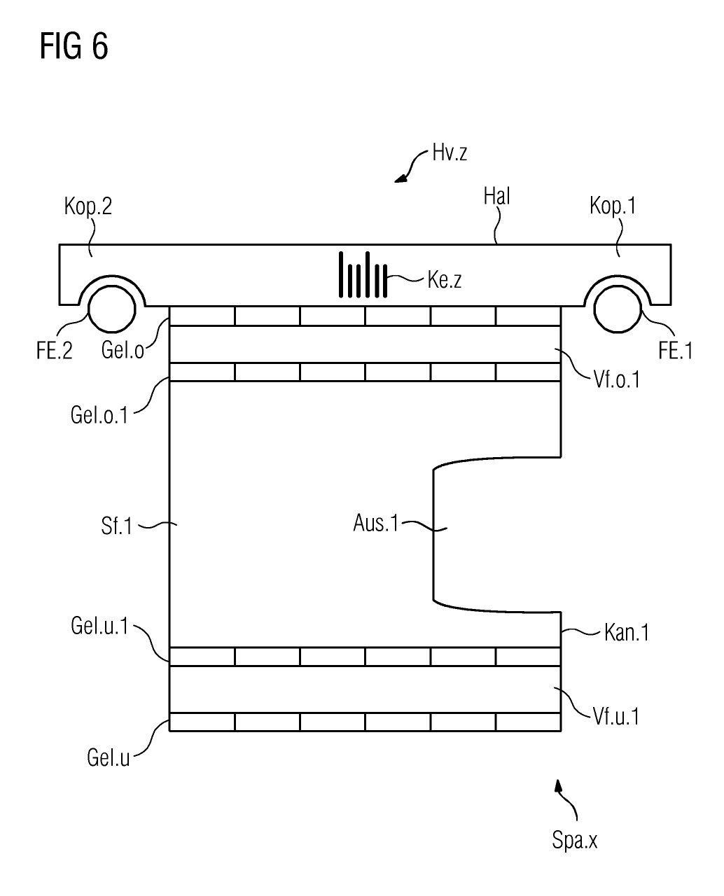

A machine-readable identification Ke.x in the form of a bar pattern is applied to the holder Hal of the holding apparatus Hv.x in FIG. 2. FIG. 6 shows a holding apparatus Hv.x with a machine-readable identification Ke.z.

A respective data set for each mail item is stored in the mail item data store Ps-DB. As soon as a loading station Bel has put a mail item Ps-4 into a holding apparatus Hv-4, the identification of the holding apparatus is read, and the data set for the mail item is supplemented by a coding of the identification of the holding apparatus. This makes it possible to re-read the identification of a holding apparatus later on and, by reading access to the mail item data store Ps-DB and to the sorting plan, to establish which sorting output SAus.1, SAus.2, . . . has been selected in the holding apparatus for the mail item.

The holding apparatuses are configured without a dedicated drive. The sorting and transporting device Sort transports the holding apparatuses with the aid of a central drive An. Each holding apparatus is pulled by a suitable transfer means or moved in another manner and slides in guide rails. The filled holding apparatuses are transported along the closed conveyor track and, when necessary, along further conveyor tracks and, in the process, are transported depending on the measured sorting feature values of the mail items in the holding apparatuses.

In one refinement, the holding apparatuses are brought into a single sequence. This sequence corresponds to the prescribed order among the occurring sorting feature values.

In one refinement, a plurality of sorting passes are carried out in succession. After the first sorting pass, the holding apparatuses with the mail items are transported back from the sorting outputs SAus.1, SAus. 2, . . . back to the feeder ZE and pass again through the sorting installation.

In a deviation, two sorting passes are carried out on two series-connected sorting installations. The mail items in the holding apparatuses pass through the first sorting installation during the first sorting pass, and the first sorting installation distributes the mail items to the sorting outputs. The holding apparatuses with the mail items are transported to the feeder of the second sorting installation. The mail items in the holding apparatuses pass through the second sorting installation in the second sorting pass.

Each mail item remains in the holding apparatus at least until the single sorting pass or the final sorting pass has been completed. The mail items merely need to be singulated before the first sorting pass but not before a subsequent sorting pass. Each mail item therefore passes a single time through the singulator Ver. It is possible for mail items in holding apparatuses to be transported away from the sorting installation with the aid of transporting containers. A previously empty holding apparatus is preferably used in each case for each mail item, therefore only one mail item is located in the holding apparatus. This makes it possible to identify the mail item even in the transporting containers with reference to a machine-readable identification on the holding apparatus.

The mail items are removed from the holding apparatuses after the sorting has been completed or else only at a later time. A flat mail item to be removed is in a vertical position in the holding apparatus and, in the exemplary embodiment, is pulled laterally out of the holding apparatus by a movement of the mail item relative to the holding apparatus. As a result, the holding apparatus is emptied and is capable then of receiving a new mail item.

The holding apparatuses are described in more detail below.

In the exemplary embodiment, each holding apparatus contains two side surfaces which are of identical height, are arranged in parallel and are approximately rectangular. Each side surface extends in a plane. Each flat mail item extends in an article plane. The mail item is held and transported in the holding apparatus in such a manner that the two plane side surfaces and the article planes are all parallel to one another and are arranged approximately vertically. The holding apparatus with the mail item hangs on the coupling element or the coupling elements.

The two side surfaces Sf.1, Sf.2 are connected to each other by at least one connecting element Vf.u which, in one refinement, is connected to the side surface at the respective lower edge of the side surface. The connecting element Vf.u prevents a mail item from dropping downward out of the holding apparatus. The two side surfaces Sf.1, Sf.2 are also connected to each other at other points by connecting elements.

The connecting elements Vf.o, Vf.u are preferably connected to each side surface in an articulated manner. Each connecting element contains two connecting components which are connected to each other in an articulated manner. For example, the articulated connection is realized by a hinge. This refinement makes it possible for each connecting element to be mounted rotatably about an axis of rotation relative to each side surface Sf.1, Sf.2. This in turn has the effect that the distance between the two side surfaces Sf.1, Sf.2 can be changed, and mail items of differing thickness can be put into the holding apparatus.

In another refinement, a connecting element is configured as a single piece and from a single material and has one thin and two thicker points, for example a thin strip. The thin strip divides the planar connecting element into two connecting components on the left and right of the strip. The two connecting components on the left and right of the strip are thicker than the thin strip. Owing to the thin strip, the thicker connecting components can pivot relative to each other, in particular can rotate relative to each other. The thin strip therefore forms a film hinge.

Preferably, at least one resilient element Fed.1, Fed.2 acts on a side surface and on a connecting element connected to the side surface. This refinement has the effect that the distance between the two side surfaces Sf.1, Sf.2 is increased counter to the force of the resilient element or of the resilient elements, and the resilient elements are arranged in such a manner that they reduce the distance. This in turn has the effect that a mail item bears in a planar manner against the two side surfaces, specifically even if mail items of differing thickness are transported in succession in the same holding apparatus. The planar contact and the force of the resilient elements hold the mail item in the holding apparatus and prevent the mail item from sliding out of the holding apparatus. The distance between the side surfaces can be increased only counter to the restoring spring force of the spring element.

It is also possible to produce at least one planar connecting element from a flexible material. The distance between the side surfaces Sf.1, Sf.2 can then also be changed because of the flexibility. However, this does not arise in each case, i.e. there is planar contact between the mail item and the side surfaces Sf.1, Sf.2 for each thickness of a mail item.

In one refinement, the two side surfaces Sf.1, Sf.2 are manufactured from a flexible, preferably elastic material. As a result, the holding apparatus is capable of receiving mail items of differing thickness, wherein a thick mail item bulges the side surfaces Sf.1, Sf.2.

In one refinement, the two elastic side surfaces Sf.1, Sf.2 are configured in such a manner that the two elastic side surfaces—or at least one side surface—are bent or curved in some other way in the rest state. The side surfaces Sf.1, Sf.2 are clamped at the upper and lower edges thereof in a respective elongate, for example rod-shaped, holder Hal. The two side surfaces are clamped concavely in the two holders, i.e. the distance between the upper edges of the side surfaces Sf.1, Sf.2 is greater than the distance at the central height of the side surfaces, and the same applies to the lower edges. A mail item which is pushed laterally between the concave side surfaces Sf.1, Sf.2 pushes the two concave side surfaces apart in the center. The pushed-apart side surfaces exert a counterpressure on the held mail item. The same holding apparatus can be used for mail items of differing thickness. Identical holding apparatuses can transport mail items of differing thickness.

In one refinement, a mail item can be put from above and from one side between the two side surfaces when the two side surfaces are arranged vertically. The other lateral edge of each side surface is closed by a connecting surface between the two side surfaces. The connecting surface connects the two other lateral edges of the side surfaces.

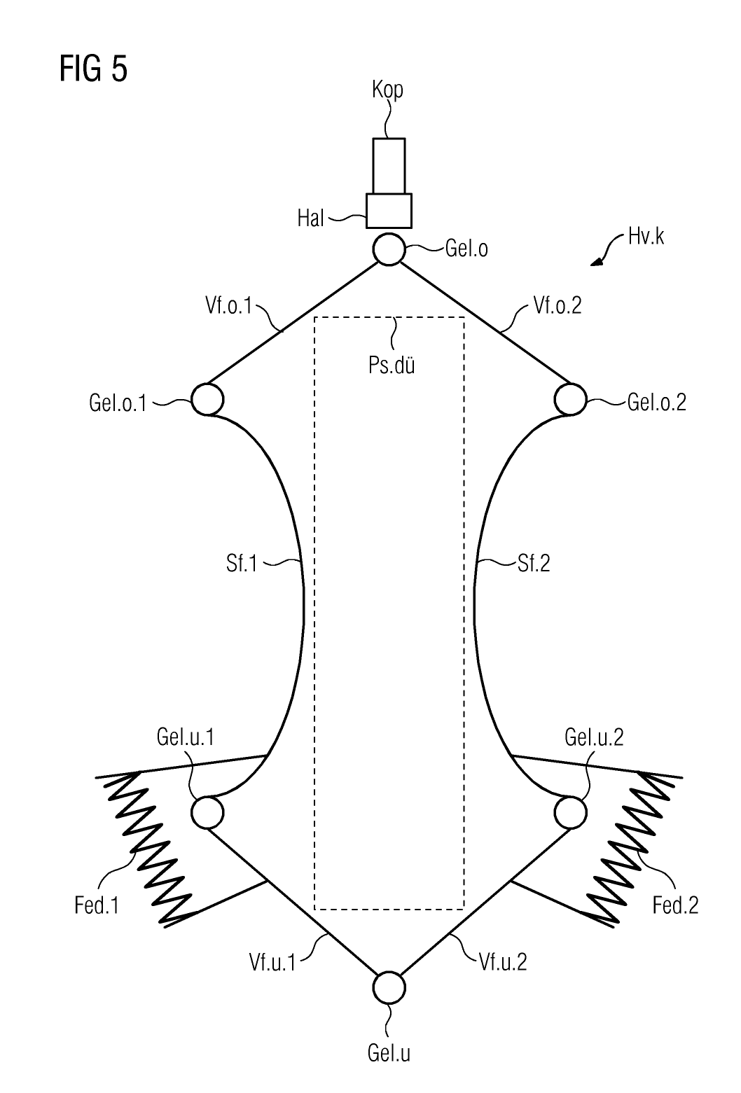

FIG. 5 shows by way of example a holding apparatus Hv.k with two concave side surfaces Sf.1, Sf.2. The side surfaces Sf.1, Sf.2 which are curved concavely inward clamp the mail item Ps.dü between them.

In another refinement, a mail item can be introduced from above and from both sides into the holding apparatus. The two side surfaces Sf.1, Sf.2 are only connected at the lower edges by a planar connecting element and at the side edges only by spot-shaped connecting elements.

In a further refinement, the two side surfaces Sf.1, Sf.2 are connected at their respective upper and lower edges by a respective planar connecting element. This refinement makes it possible to provide the two connecting surfaces with resilient elements. The prestress exerted by the resilient elements results in the side surfaces being pressed onto the mail item and holds the mail item in the holding apparatus.

The holding apparatus hangs on a transporting and guiding device during transportation. The transporting and guiding device contains at least one rod-shaped holder, for example a rail or chain. A coupling element of the holding apparatus engages in the holder. For example, a hook of the coupling element engages around the rail or chain. It is possible for the transporting and guiding device to move the holder and for the moving holder to entrain the coupling element and therefore the holding apparatus with a mail item. For example, the coupling element of the holding apparatus engages in a recess in the moving holder. The coupling element is, for example, in the shape of a hook with a semicircular head.

In one refinement, the holding apparatus has a centrally arranged coupling element on which the holding apparatus hangs while the holding apparatus is transported. FIG. 2 shows a holding apparatus Hv.x with a centrally mounted coupling element Kop.

In another refinement, the holding apparatus has two laterally mounted coupling elements. The transporting and guiding device has two rod-shaped holders. The distance between the two laterally mounted coupling elements of the holding apparatus is matched to the distance between the two rod-shaped holders, and therefore the two coupling elements interact with the two holders, and the holding apparatus rests on the two holders.

FIG. 6 shows a holding apparatus Hv.z with a rigid holder Hal and two laterally mounted coupling elements Kop.1, Kop.2. The two coupling elements Kop.1, Kop.2 are connected to the rigid holder Hal. The side surfaces Sf.1, Sf.2 are arranged parallel to the plane of projection of FIG. 6. The coupling element Kop.1 engages in a guiding device FE.1 which is in the form of a rail. The coupling element Kop.2 engages in a guide element FE.2 which is likewise in the form of a rail.

A combination of the two refinements is also possible, namely by the holding apparatus having a central coupling element Kop and two lateral coupling elements Kop.1, Kop.2. This refinement makes it possible for the holding apparatus to be used either in a transporting and guiding device having a single rod shaped guide or holder or in a transporting and guiding device having two holders.

In the exemplary embodiment, a respective recess is let into the two side surfaces Sf.1, Sf.2 of the holding apparatus. The two recesses in the two side surfaces of a holding apparatus each have a recess region. The recess region may be identical to the entire recess or may only take up part of the recess. The two recess regions preferably correspond with regard to the dimensions thereof, the shape thereof and the position thereof. Each recess begins in a lateral edge of the side surface and tapers away, as seen from the edge. The two recess regions from a continuous opening in the two side surfaces of the holding apparatus. If a mail item is located in the holding apparatus, it is possible to look through the continuous opening.

FIG. 2 shows two congruent recesses Aus.1, Aus.2 in the two side surfaces Sf.1, Sf.2. The two recesses Aus.1, Aus.2 begin at the two lateral edges Kan.1, Kan.2 of the two side surfaces SF.1, Sf.2. In the example in FIG. 2, the two recesses Aus.1, Aus.2 taper inward, i.e. toward the other edge in each case.

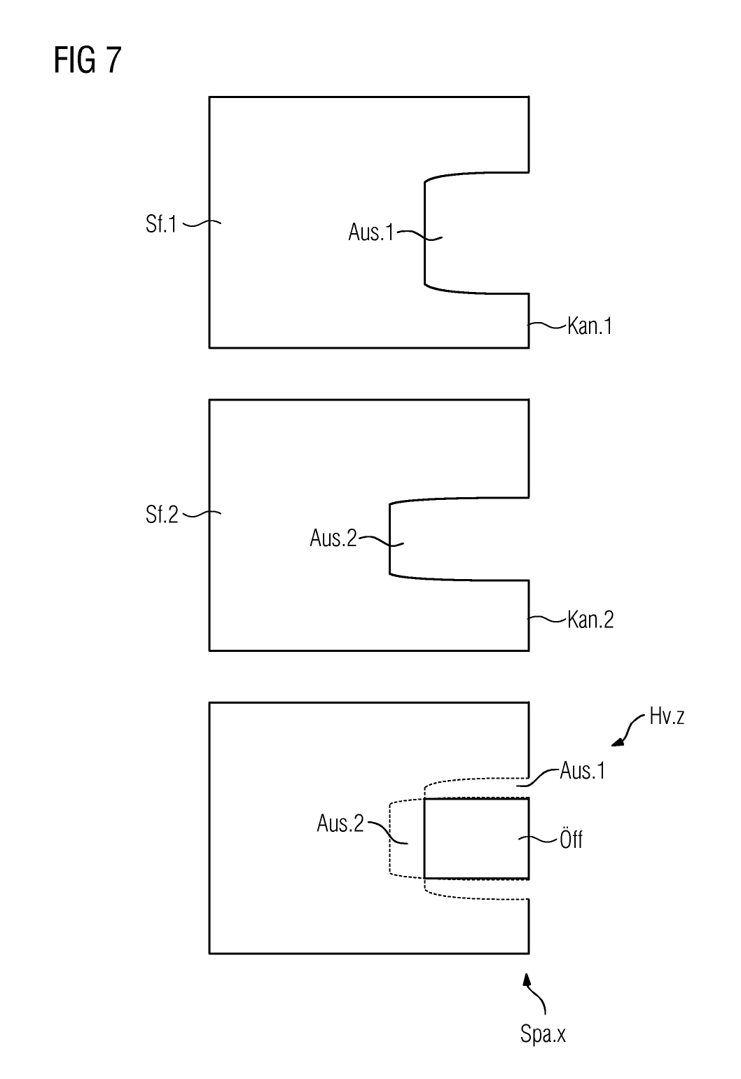

FIG. 7 illustrates the refinement of the holding apparatus Hv.z with a continuous opening Öff. FIG. 7 shows, at the top, the side surface Sf.1 with the recess Aus.1 which begins at the edge Kan.1. FIG. 7 shows, in the center, the side surface Sf.2 with the recess Aus.2 which begins at the edge Kan.2. Both side surfaces Sf.1, Sf.2 are shown from the same viewing direction. The recesses Aus.1, Aus.2 are not congruent. FIG. 7 shows, at the bottom, the holding apparatus Hv.2 from the same viewing direction. It can be seen that the common region of the recesses Aus.1 and Aus.2 forms a continuous opening Öff. A gripping apparatus with two grippers can grip a mail item in the holding apparatus Hv.z through the opening Öff.

The recesses furthermore make it possible to apply a sticker or a stamp or else a mobile data carrier automatically or else manually to a mail item in the holding apparatus, without having to remove the mail item from the holding apparatus, and, as a result, for example, to identify the mail item. The sticker or stamp or data carrier can be applied either to the front side or to the rear side of the mail item. In one refinement, the sticker is applied to the mail item in such a manner that the sticker projects laterally over the side edge of the mail item and also over the lateral edges Kan.1, Kan.2 of the holding apparatus. This makes it possible to mark the beginning or the end of a run of mail items in a sequence of sorted mail items while the mail items are located in respective holding apparatuses. The recesses Aus.1, Aus.2 in the side surfaces Sf.1, Sf.2 also make it easier to grasp the mail items in the holding apparatus from the side and to pull the mail items out of the holding apparatus or else to push the mail items into the holding apparatus.

By means of the following different refinements which can be combined, a mail item can be prevented from sliding out of the holding apparatus: by elastic side surfaces Sf.1, Sf.2 which are bent outward, i.e. away from each other, by a mail item and hold the mail item by means of a driving-back force, a sufficiently large coefficient of friction of the inner sides of the side surfaces Sf.1, Sf.2, a respective resilient element between a planar connecting element and a side surface, a planar connecting element which is divided in two in the longitudinal direction, and a hinge with a resilient element as connecting member between the two connecting components of the connecting surface, clamping in the base edge, the clamping being obtained by means of a gap in the base edge, wherein the mail item slips under its own weight into the gap and is held by the gap.

In one refinement, the two side surfaces Sf.1, Sf.2 are connected to each other at the upper edges thereof by a connecting surface. In one embodiment, the connecting surface is connected in an articulated manner to the side surface Sf.1, Sf.2. In another refinement, the connecting surface is configured in such a manner that the two side surfaces are connected to each other in a frictional and/or form-fitting manner. For example, the connecting surface is configured in the manner of a thin bar, and each side surface is inserted into a respective slot or other recess in the bar-shaped connecting surface. This refinement makes it possible for transverse forces within the holding apparatus to be dissipated, rather than act on the mail item, when the holding apparatus is transported together with a mail item. The connecting surface is preferably of a strength such that the holding apparatus cannot be buckled or pushed together.

In one refinement, the sorting installation contains at least one unloading station Ent. In the unloading station Ent, the mail items are pulled out of the holding apparatuses. Before the unloading, the holding apparatus holds the mail item between the two side surfaces of the holding apparatus. The side surfaces and the mail items are arranged approximately perpendicularly and parallel to one another.

In the exemplary embodiment, the unloading station Ent contains a gripping apparatus Gv. For unloading purposes, the gripping apparatus Gv grips the mail item through the two recesses. The gripping apparatus has two grippers Gf.1, Gf.2 which are in the form, for example, of rollers or gripper arms. Each gripper Gf.1, Gf.2 reaches through a respective recess in the side surface. The distance between the grippers Gf.1, Gf.2 is reduced until the two grippers bear against the mail item and thereby grasp the mail item between them. The mail item is now moved relative to the holding apparatus.

In one refinement, the mail item is pulled laterally out of the holding apparatus by means of an approximately horizontal linear movement. In this case, the holding apparatus is preferably held in such a manner that the holding apparatus is not rotated at the same time. If the holding apparatus has two coupling elements, just the lever arm between the two coupling elements prevents undesired rotation. In another refinement, the holding apparatus is rotated or pulled laterally. The gripping apparatus Gv secures the mail item, and the holding apparatus is pulled off from the mail item.

In one refinement, the friction between the two elastic side surfaces Sf.1, Sf.2 and the mail item is additionally reduced by the distance between the upper and the lower edges of the two side surfaces being reduced, i.e. the holding apparatus being compressed. The transverse pressure of the side surfaces on the mail item is reduced as a result.

The sorting installation has a multiplicity of holding apparatuses according to the solution. The holding apparatuses preferably correspond in the following parameters: in the case of two lateral coupling elements, the distance of the coupling elements from each other, the number of connecting elements per holding apparatus, and in the case of a recess in each side surface, the distance of the recess from the lower edge of the side surface.

The invariable distance of the recesses from the respective lower edge makes it easier to align the mail items at the lower edges thereof in the holding apparatuses, for example by the mail items being placed onto a surface in the holding apparatuses and the surface being shaken. The invariable distance between the two coupling elements makes it possible to allow a holding apparatus to be transported by the same transporting and guiding device and to manage with two rails.

The holding apparatuses can differ in the following parameters: height of the side surfaces, and width of the side surfaces.

As a result, the sorting installation is capable of transporting and sorting mail items of differing dimensions.

1. A sorting installation for sorting articles on a basis of a sorting feature, the sorting installation comprising:
at least one loading station;
a measuring instrument;
a sorting and transporting device;
a plurality of holding apparatuses each having two mutually parallel side surfaces and at least two spaced-apart connecting elements between said two parallel side surfaces, each of said at least two connecting elements connected in an articulated manner to said two side surfaces, said two side surfaces and said at least two connecting elements enclose a enclosed space which is capable of receiving an article to be transported;
at least one unloading station;
said measuring instrument configured for the purpose, for each article to be sorted, of measuring what value the sorting feature assumes for the article;
said loading station putting each of the articles to be sorted into said enclosed space of one of said holding apparatuses in each case in such a manner that the article is disposed in a space between said two side surfaces and said at least two connecting elements, and is held by said holding apparatus;
said sorting and transporting device transporting each of the articles to be sorted in said holding apparatus to said at least one unloading station;
said sorting and transporting device sorting said holding apparatuses in accordance with a measured sorting feature values of the articles disposed in said holding apparatuses;
said unloading station removing the article to be sorted from said holding apparatus;
spring elements;
at least one of said holding apparatuses is configured such that each said connecting element is mechanically connected to at least one of said side surfaces by means of one of said spring elements;
each of said connecting elements of said holding apparatus having two connecting components, each of said connecting components connected in an articulated manner to a respective said side surface of said holding apparatus, said two connecting components of said connecting element are connected in an articulated manner to each other; and
each of said spring elements acting on said connecting element and on at least one said side surface in such a manner that said spring element reduces a distance between said two side surfaces of said holding apparatus, an increase in the distance between said two side surfaces brings about a restoring spring force of said spring element, the restoring spring force acting counter to an increase in the distance.

2. The sorting installation according to claim 1, wherein:
said holding apparatus which has said spring element contains a further connecting element;
said holding apparatus is configured such that the article which is held by said holding apparatus is disposed in the space between said two side surfaces and said two connecting elements; and
at least one of said side surfaces is of a curved configuration in such a manner that said two side surfaces form a concave object.

3. The sorting installation according to claim 2, wherein:
each said curved side surface of said holding apparatus is an elastic object; and
said holding apparatus is configured such that a putting of the article into said holding apparatus causes each said side surface being a curved and elastic side surface to be bent away from the other side surface.

4. The sorting installation according to claim 1, wherein at least one of said holding apparatus has two recesses formed therein, a respective one of said recesses is embedded in each said side surface of said holding apparatus, said two side surfaces are disposed such that said two recesses each have a recess region, and said recess regions are congruent in such a manner that said two recess regions form a continuous opening in said two side surfaces.

5. The sorting installation according to claim 1, wherein:
said sorting installation is configured such that said connecting element with said two connecting components is disposed below said side surfaces whenever the article in said holding apparatus is transported with said connecting element; and
said two connecting components are connected to each other such that said connecting element has a V-shaped cross section, wherein an angle between limbs of said V-shaped cross section can be changed.

6. A sorting method for sorting a plurality of articles on a basis of a sorting feature, which comprises the steps of:
providing a sorting installation, containing:
at least one loading station;
a plurality of holding apparatuses;
at least one unloading station; and
each of the holding apparatuses has two mutually parallel side surfaces and at least two spaced-apart connecting elements between the two parallel side surfaces, the two side surfaces and the at least two connecting elements enclose a space which is capable of receiving an article to be transported, each of the at least two connecting elements is connected in an articulated manner to the two side surfaces;
measuring what value the sorting feature assumes for the article;
putting, via the loading station, the article into a holding apparatus such that the article is disposed in an enclosed space between the two side surfaces and the at least two connecting elements and is held by the holding apparatus;
transporting the article in a respective holding device to the unloading station;
removing, via the unloading station, the article from the holding apparatus;
sorting the holding apparatus in accordance with measured sorting feature values of the articles located in the holding apparatuses;
configuring at least one of the holding apparatuses such that each of the connecting elements is mechanically connected to at least one side surface by a spring element; and
during the step of putting the article into the holding apparatus, the loading station increases a distance between the two side surfaces of the holding apparatus counter to a force of at least one spring element of the holding apparatus, an increase in the distance causes each of the connecting components to be pivoted relative to one side surface in each case, and subsequently at least one spring element of the holding apparatus reduces the distance between the two side surfaces such that the two side surfaces clamp the article, which has been put into the holding apparatus, therebetween.

7. The sorting method according to claim 6, which further comprises:
placing a first article in a same holding apparatus with the at least two spring elements;
subsequently removing the first article again from the holding apparatus; and
subsequently putting a second article into the holding apparatus, wherein the two side surfaces bear both against the first article and against the second article, and the distance between the two side surfaces in the case of the first article is different than in the case of the second article.
